(19) United States
(12) Patent Application Publication
(10) Pub. No.: US 2022/0027838 A1
(43) Pub. Date: Jan. 27, 2022

(54) DELIVERY PLAN GENERATION DEVICE, COMPUTER PROGRAM, AND DELIVERY PLAN GENERATION METHOD

(71) Applicant: Sumitomo Electric Industries, Ltd., Osaka-shi, Osaka (JP)

(72) Inventor: Tomomi KATAOKA, Osaka-shi, Osaka (JP)

(73) Assignee: Sumitomo Electric Industries, Ltd., Osaka-shi, Osaka (JP)

(21) Appl. No.: 17/279,604

(22) PCT Filed: Sep. 13, 2019
(86) PCT No.: PCT/JP2019/036169

§ 371 Date: Mar. 25, 2021

(51) Int. Cl. G06Q 10/08; B60L 58/12; B60L 58/16

(52) U.S. Cl. CPC G06Q 10/083; B60L 58/12; B60L 2240/62; B60L 2240/547; B60L 58/16

(57) ABSTRACT

This delivery plan generation device includes: a vehicle information acquisition unit configured to acquire vehicle information of an electric vehicle; an SOC acquisition unit configured to acquire an SOC of a secondary battery mounted to the electric vehicle; a delivery destination information acquisition unit configured to acquire delivery destination information of a package; a calculation unit configured to calculate a traveling possible distance of the electric vehicle on the basis of the vehicle information and the SOC of the secondary battery; and a delivery plan generation unit configured to generate the delivery plan, using the delivery destination information and the calculated traveling possible distance.

### TECHNICAL FIELD

The present disclosure relates to a delivery plan generation device, a computer program, and a delivery plan generation method.

This application claims priority on Japanese Patent Application No. 2018-202982 filed on Oct. 29, 2018, the entire content of which is incorporated herein by reference.

### BACKGROUND ART

In delivering multiple packages by a plurality of vehicles, there is known a delivery plan application capable of automatically performing calculation about on which vehicle each package should be loaded and through which route should be taken, to perform efficient delivery.

Patent Literature 1 discloses a delivery plan creation assisting method capable of planning loading by selecting an appropriate vehicle on the basis of delivery destination information, package information, and vehicle information and creating a delivery plan that allows address information and the package information to be associated with each other on a map.

### CITATION LIST

### Patent Literature

PATENT LITERATURE 1: Japanese Laid-Open Patent Publication No. 2001-109983

### SUMMARY OF INVENTION

A delivery plan generation device of the present disclosure is a delivery plan generation device configured to generate a delivery plan for a package by an electric vehicle to which a secondary battery is mounted, the delivery plan generation device including: a vehicle information acquisition unit configured to acquire vehicle information of the electric vehicle; an SOC acquisition unit configured to acquire an SOC of the secondary battery mounted to the electric vehicle; a delivery destination information acquisition unit configured to acquire delivery destination information of the package; a calculation unit configured to calculate a traveling possible distance of the electric vehicle on the basis of the vehicle information and the SOC of the secondary battery; and a delivery plan generation unit configured to generate the delivery plan, using the delivery destination information and the traveling possible distance calculated by the calculation unit.

A computer program of the present disclosure is a computer program for causing a computer to generate a delivery plan for a package by an electric vehicle to which a secondary battery is mounted, the computer program causing the computer to execute: processing of acquiring vehicle information of the electric vehicle; processing of acquiring an SOC of the secondary battery mounted to the electric vehicle; processing of acquiring delivery destination information of the package; processing of calculating a traveling possible distance of the electric vehicle on the basis of the vehicle information and the SOC of the secondary battery; and processing of generating the delivery plan, using the delivery destination information and the calculated traveling possible distance.

A delivery plan generation method of the present disclosure is a delivery plan generation method for generating a delivery plan for a package by an electric vehicle to which a secondary battery is mounted, the delivery plan generation method including: acquiring vehicle information of the electric vehicle; acquiring an SOC of the secondary battery mounted to the electric vehicle; acquiring delivery destination information of the package; calculating a traveling possible distance of the electric vehicle on the basis of the vehicle information and the SOC of the secondary battery; and generating the delivery plan, using the delivery destination information and the calculated traveling possible distance.

### BRIEF DESCRIPTION OF DRAWINGS

FIG. 1 is a block diagram showing an example of a configuration of a delivery plan generation device of the present embodiment.

FIG. 2 is a schematic diagram showing an example of a configuration of a vehicle information DB.

FIG. 3 is a schematic diagram showing an example of a configuration of a battery pack information DB.

FIG. 4 is a schematic diagram showing an example of a configuration of a package information DB.

FIG. 5 is a schematic diagram showing an example of allocation information of battery packs.

FIG. 6 is a schematic diagram showing an example of a delivery plan.

FIG. 7 is a schematic diagram showing an example of a charging plan for the battery packs.

FIG. 8 is a schematic diagram showing a first example of charging of the battery packs by a charging device.

FIG. 9 is a schematic diagram showing a second example of charging of the battery packs by the charging device.

FIG. 10 is a flowchart showing an example of a processing procedure in the delivery plan generation device of the present embodiment.

### DESCRIPTION OF EMBODIMENTS

### Problems to be Solved by the Present Disclosure

In general, for vehicles using gasoline or light oil as fuel, an operation of filling up a fuel tank after returning to a delivery base or before departing from the delivery base, or an operation of stopping by a gas station for refueling during delivery, can be employed. However, in a case of using an electric vehicle as a delivery vehicle, it takes a comparatively long time to charge a battery, and therefore stopping by a charging station for charging during delivery leads to reduction in delivery efficiency. In addition, if the battery is charged each time of returning to the delivery base, charging is repeated in a state close to a full charge state, thus causing a problem of promoting deterioration of the battery.

Accordingly, an object is to provide a delivery plan generation device, a computer program, and a delivery plan generation method that are capable of generating a delivery plan using an electric vehicle to which a secondary battery is mounted.

### Effects of the Present Disclosure

According to the present disclosure, it is possible to generate a delivery plan using an electric vehicle to which a secondary battery is mounted.

### Description of Embodiments of the Present Disclosure

A delivery plan generation device according to the present embodiment is a delivery plan generation device configured to generate a delivery plan for a package by an electric vehicle to which a secondary battery is mounted, the delivery plan generation device including: a vehicle information acquisition unit configured to acquire vehicle information of the electric vehicle; an SOC acquisition unit configured to acquire an SOC of the secondary battery mounted to the electric vehicle; a delivery destination information acquisition unit configured to acquire delivery destination information of the package; a calculation unit configured to calculate a traveling possible distance of the electric vehicle on the basis of the vehicle information and the SOC of the secondary battery; and a delivery plan generation unit configured to generate the delivery plan, using the delivery destination information and the traveling possible distance calculated by the calculation unit.

A computer program according to the present embodiment is a computer program for causing a computer to generate a delivery plan for a package by an electric vehicle to which a secondary battery is mounted, the computer program causing the computer to execute: processing of acquiring vehicle information of the electric vehicle; processing of acquiring an SOC of the secondary battery mounted to the electric vehicle; processing of acquiring delivery destination information of the package; processing of calculating a traveling possible distance of the electric vehicle on the basis of the vehicle information and the SOC of the secondary battery; and processing of generating the delivery plan, using the delivery destination information and the calculated traveling possible distance.

A delivery plan generation method according to the present embodiment is a delivery plan generation method for generating a delivery plan for a package by an electric vehicle to which a secondary battery is mounted, the delivery plan generation method including: acquiring vehicle information of the electric vehicle; acquiring an SOC of the secondary battery mounted to the electric vehicle; acquiring delivery destination information of the package; calculating a traveling possible distance of the electric vehicle on the basis of the vehicle information and the SOC of the secondary battery; and generating the delivery plan, using the delivery destination information and the calculated traveling possible distance.

The vehicle information acquisition unit acquires vehicle information of the electric vehicle. The vehicle information can include, for example, a vehicle ID for identifying the vehicle, the dimensions (length, width, height) of a platform, a load capacity, the number of mounted secondary batteries (also called battery packs), and the like.

The SOC acquisition unit acquires the state of charge (SOC) of the secondary battery mounted to the electric vehicle. The SOC of the secondary battery can be acquired from a management device (e.g., battery management system (BMS)) for managing the state of the secondary battery mounted to the electric vehicle, for example.

The delivery destination information acquisition unit acquires delivery destination information of the package. The delivery destination information includes, for example, information indicating where to deliver each package.

The calculation unit calculates a traveling possible distance for the electric vehicle on the basis of the vehicle information and the SOC of the secondary battery. The electric vehicle is, for example, an electric vehicle that has returned to the delivery base and that can be used for the next delivery. The traveling possible distance is calculated from the remaining capacity without charging the secondary battery mounted to the electric vehicle. The traveling possible distance can be calculated by a function with variables being a total weight (load capacity+vehicle body weight) of the electric vehicle and the SOC.

The delivery plan generation unit generates the delivery plan, using the delivery destination information and the calculated traveling possible distance. For example, using the traveling possible distance of the electric vehicle as a constraint condition, a delivery plan in which delivery destinations to which delivery is possible within the traveling possible distance are specified, can be generated. In addition, in a case where there is a remaining package to be delivered, the same processing may be repeated for another electric vehicle.

With the above configuration, the secondary battery mounted to the electric vehicle that has returned to the delivery base is not unconditionally charged, and thus it is possible to inhibit the secondary battery from being deteriorated by being repeatedly charged in a state close to a full charge state. In addition, it is not necessary to stop by a charging station during delivery and it is possible to generate the delivery plan using the electric vehicle to which the secondary battery is mounted.

In the delivery plan generation device according to the present embodiment, the delivery plan generation unit generates the delivery plan in which a delivery order of a plurality of delivery destinations is specified.

The delivery plan generation unit generates the delivery plan in which the delivery order of a plurality of delivery destinations are specified. For example, the delivery order can be specified so that the traveling distance from departure from the delivery base to return thereto is minimized. Thus, it becomes possible to include many delivery destinations within a range of the remaining capacity of the secondary battery mounted to the electric vehicle, or it is possible to generate the delivery plan effectively using the electric vehicle having a less remaining capacity.

In the delivery plan generation device according to the present embodiment, the delivery plan generation unit generates the delivery plan including allocation information of the secondary battery to be mounted to the electric vehicle for each delivery route from departure from a base to return to the base.

The delivery plan generation unit generates the delivery plan including allocation information of the secondary battery to be mounted to the electric vehicle for each delivery route from departure from a base to return to the base. The allocation information can indicate the correspondence relationship among vehicle IDs, secondary battery IDs, and delivery route IDs, for example. Thus, the secondary battery detached from the electric vehicle once can be allocated to another electric vehicle, and thus the remaining capacity of the secondary battery can be effectively used (i.e., used for the next delivery without being charged).

In the delivery plan generation device according to the present embodiment, the delivery plan generation unit generates the delivery plan on the basis of the SOC of the secondary battery and a first threshold.

In a case where the SOC of the secondary battery is equal to or greater than the first threshold, the delivery plan generation unit generates the delivery plan using the traveling possible distance calculated by the calculation unit on the basis of the SOC. The first threshold can be set as appropriate, and for example, can be set to 20%, 30%, or the like. In a case where the distance of the delivery route at the delivery base is long, the first threshold may be increased, and in a case where the distance of the delivery route at the delivery base is comparatively short, the first threshold may be reduced. Thus, repetition of charging in a state close to a full charge state is inhibited, whereby deterioration of the secondary battery can be inhibited.

The delivery plan generation device according to the present embodiment further includes a charging plan generation unit configured to generate a charging plan for the secondary battery on the basis of the SOC of the secondary battery and the first threshold.

In a case where the SOC of the secondary battery is smaller than the first threshold, the charging plan generation unit generates the charging plan for the secondary battery. Performing charging in a case where the SOC is smaller than the first threshold does not lead to promotion of deterioration of the secondary battery. Therefore, by charging the secondary battery, it is possible to increase the traveling possible distance of the electric vehicle to which the secondary battery is mounted, thus enabling delivery of packages to many destinations.

In the delivery plan generation device according to the present embodiment, the charging plan generation unit includes, in the charging plan, a target value for the SOC of the secondary battery.

The charging plan generation unit includes, in the charging plan, the target value for the SOC of the secondary battery. The target value may be set to, for example, the upper limit value of the SOC (e.g., 100% or 95%), or depending on the delivery route or the departure time in the next delivery plan, or the like, if it is not necessary to fully charge the secondary battery, the target value may be set to 70%, 50%, or the like. Thus, it is possible to charge the secondary battery in accordance with the delivery plan.

In the delivery plan generation device according to the present embodiment, the charging plan generation unit includes, in the charging plan, a charge completion deadline based on the delivery plan of the electric vehicle to which the secondary battery is mounted.

The charging plan generation unit includes, in the charging plan, the charge completion deadline based on the delivery plan of the electric vehicle to which the secondary battery is mounted. Thus, it is possible to charge the secondary battery so as to be ready for the delivery plan.

In the delivery plan generation device according to the present embodiment, when a voltage difference between a plurality of secondary batteries to be mounted to the electric vehicle is greater than a predetermined threshold, the charging plan generation unit generates the charging plan so as to charge at least one of the plurality of secondary batteries.

In a case where a voltage difference between a plurality of secondary batteries mounted to the electric vehicle is greater than the predetermined threshold, the charging plan generation unit generates the charging plan so as to charge at least one of the plurality of secondary batteries. For example, in a case where secondary batteries different in the capacities, battery characteristics, and the like of the secondary batteries are mounted together in one electric vehicle, a voltage difference between the plurality of secondary batteries may become greater than the predetermined threshold. In such a state, if the secondary batteries are mounted together, an excessive current flows between the plurality of secondary batteries, thus deteriorating the secondary batteries. Accordingly, for example, the secondary battery having a low voltage is charged so that the voltage difference between the plurality of secondary batteries becomes equal to or smaller than the predetermined threshold. Thus, different secondary batteries can be mounted together in the electric vehicle, whereby the secondary batteries can be effectively used.

In the delivery plan generation device according to the present embodiment, the charging plan generation unit generates the charging plan so as to charge the secondary battery having a low voltage, of the plurality of secondary batteries.

The charging plan generation unit charges the secondary battery having a low voltage so that the voltage difference between the plurality of secondary batteries becomes equal to or smaller than the predetermined threshold. Thus, different secondary batteries can be mounted together in the electric vehicle, whereby the secondary batteries can be effectively used.

The delivery plan generation device according to the present embodiment further includes a correction unit configured to correct the traveling possible distance calculated by the calculation unit, on the basis of at least one of the SOH of the secondary battery or a number of times of charging thereof.

The correction unit corrects the traveling possible distance calculated by the calculation unit, on the basis of at least one of the state of health (SOH) or the number of times of charging of the secondary batteries. For example, in a case where the SOH is reduced, the traveling possible distance can be shortened. In addition, in a case where the number of times of charging is large, the traveling possible distance can be shortened. Thus, it is possible to obtain an appropriate traveling possible distance in accordance with the state of the secondary battery.

### Details of Embodiments of the Present Disclosure

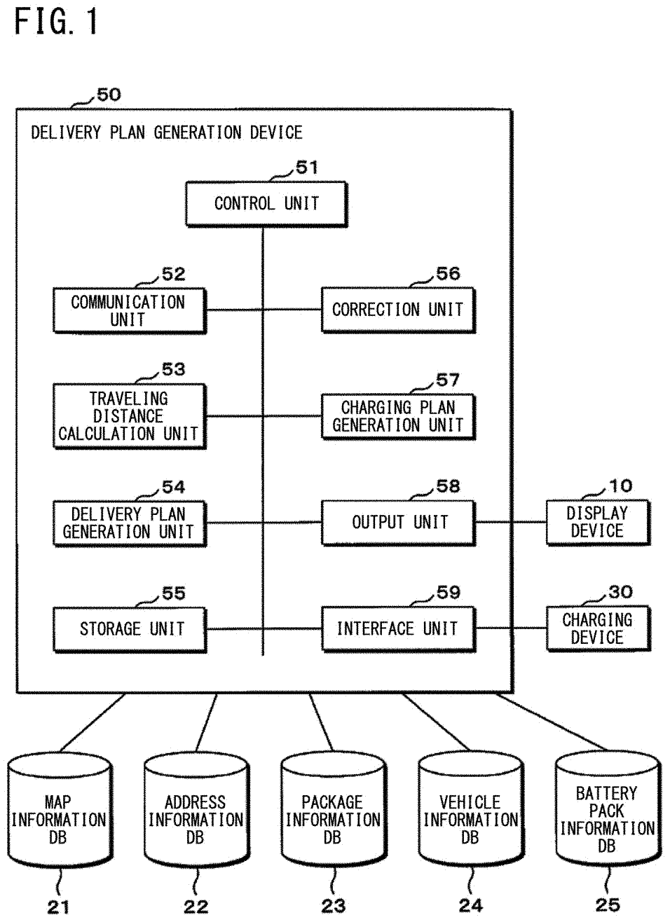

Hereinafter, a delivery plan generation device of the present embodiment will be described with reference to the drawings. FIG. 1 is a block diagram showing an example of a configuration of a delivery plan generation device 50 of the present embodiment. The delivery plan generation device 50 includes a control unit 51 for controlling the entire device, a communication unit 52, a traveling distance calculation unit 53, a delivery plan generation unit 54, a storage unit 55 storing required information, a correction unit 56, a charging plan generation unit 57, an output unit 58, and an interface unit 59. A display device 10 and a charging device 30 can be connected to the delivery plan generation device 50. The output unit 58 can output information to be displayed on the display device 10, to the display device 10. The interface unit 59 has an interface function between the interface unit 59 and the charging device 30 installed at a delivery base.

The delivery plan generation device 50 is connected to a map information DB 21, an address information DB 22, a package information DB 23, a vehicle information DB 24, and a battery pack information DB 25, and thus can read information from each DB and can store information in each DB.

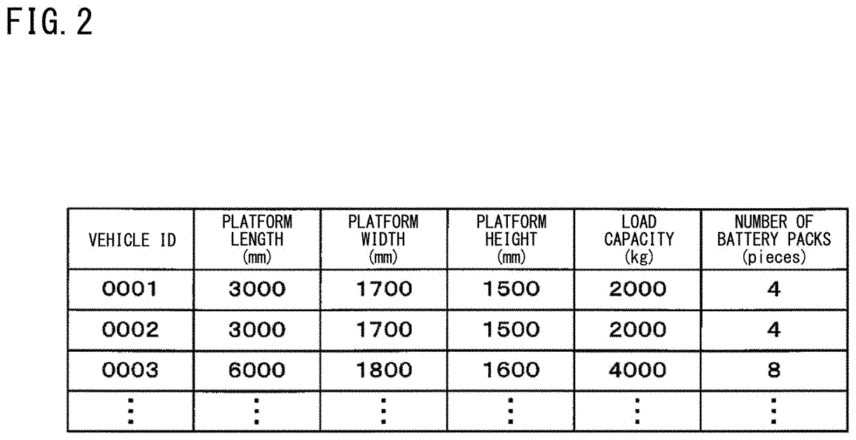

FIG. 2 is a schematic diagram showing an example of a configuration of the vehicle information DB 24. The vehicle information DB 24 has vehicle information registered for each electric vehicle. The vehicle information includes information such as a vehicle ID for identifying each vehicle, the dimensions (length, width, height) of a platform, a load capacity, and the number of mounted battery packs (secondary batteries).

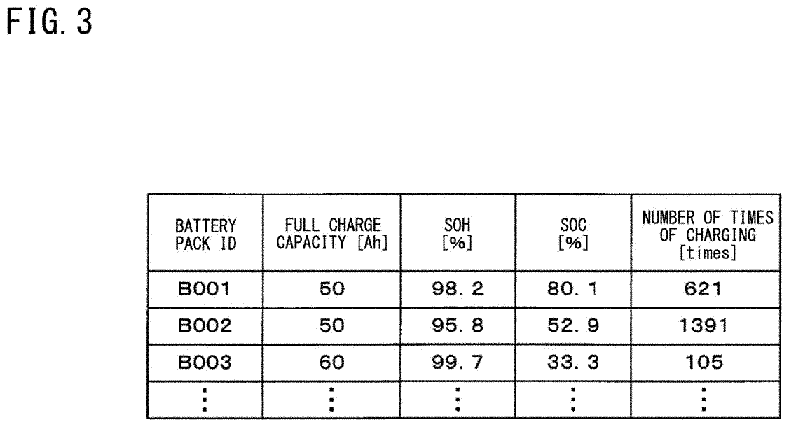

FIG. 3 is a schematic diagram showing an example of a configuration of the battery pack information DB 25. The battery pack information DB 25 has battery pack information registered for each battery pack. The battery pack information includes information such as a battery pack ID for identifying each battery pack, a full charge capacity, a state of health (SOH), a state of charge (SOC), and the number of times of charging. The SOH refers to the state of health, and is a state quantity representing a condition of the secondary battery deteriorating and reducing in capacity. The SOC refers to the state of charge, and is a state quantity representing the ratio of the remaining amount of the secondary battery with respect to a full charge state.

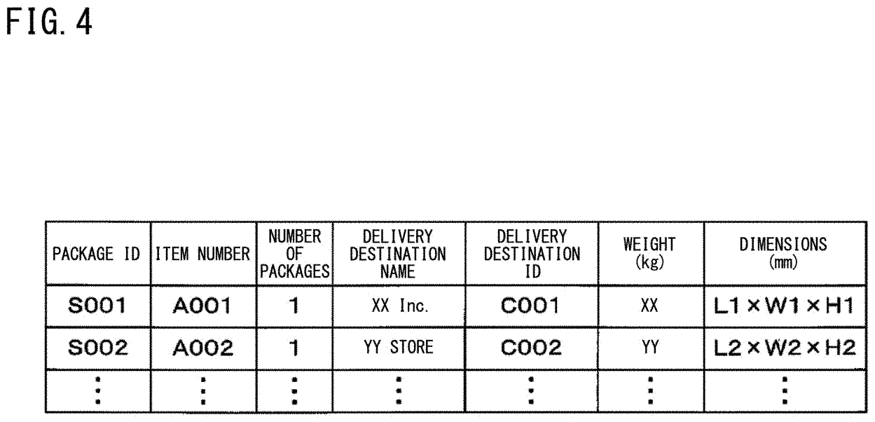

FIG. 4 is a schematic diagram showing an example of a configuration of the package information DB 23. The package information DB 23 has package information registered for each package. The package information includes information such as a package ID for identifying each package, an item number of the package, the number of packages, a delivery destination name, a delivery destination ID, a package weight, and package dimensions (length, width, height).

The control unit 51 has a function as a vehicle information acquisition unit, and acquires vehicle information of an electric vehicle to be used at the delivery base by referring to the vehicle information DB 24.

The communication unit 52 has a function for communicating with a battery management system (BMS) which manages the state of the battery pack mounted to the electric vehicle. The communication unit 52 has a function as an SOC acquisition unit, and is capable of acquiring the SOC of the battery pack mounted to the electric vehicle to be used at the delivery base. It is noted that the SOC of the battery pack detached from the electric vehicle and stored in the delivery base can be acquired by the interface unit 59 via the charging device 30.

The control unit 51 has a function as a delivery destination information acquisition unit, and acquires delivery destination information of the packages. The delivery destination information includes information indicating where to deliver each package, for example. Specifically, the control unit 51 specifies a package to be delivered at the delivery base by referring to the package information DB 23, and acquires the delivery destination information of the package by referring to the map information DB 21 and the address information DB 22.

The traveling distance calculation unit 53 has a function as a calculation unit, and calculates a traveling possible distance of the electric vehicle on the basis of the vehicle information and the SOC of the battery pack that have been acquired. The electric vehicle is, for example, an electric vehicle that has returned to the delivery base and that can be used for the next delivery. The traveling possible distance is calculated from the remaining capacity without charging the secondary battery mounted to the electric vehicle. The traveling possible distance can be calculated by a function with variables being a total weight (load capacity+vehicle body weight) of the electric vehicle and the SOC.

The delivery plan generation unit 54 generates a delivery plan using the delivery destination information and the calculated traveling possible distance. For example, using the traveling possible distance of the electric vehicle as a constraint condition, a delivery plan in which delivery destinations to which delivery is possible within the traveling possible distance are specified, can be generated. In addition, in a case where there is a remaining package to be delivered, the same processing may be repeated for another electric vehicle.

With the above configuration, the battery pack mounted to the electric vehicle that has returned to the delivery base is not unconditionally charged, and thus it is possible to inhibit the battery pack from being deteriorated by being repeatedly charged in a state close to a full charge state. In addition, it is not necessary to stop by a charging station during delivery and it is possible to generate the delivery plan using the electric vehicle to which the battery pack is mounted.

The delivery plan generation unit 54 can generate the delivery plan including allocation information of the battery packs to be mounted to the electric vehicles for each delivery route from departure from the base to return to the base.

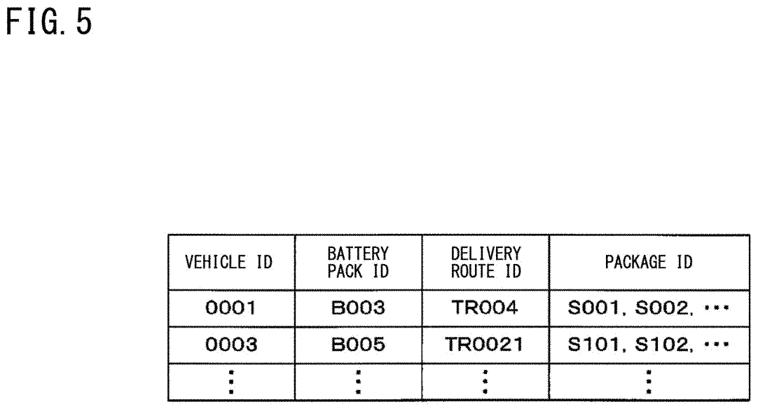

FIG. 5 is a schematic diagram showing an example of the allocation information of the battery packs. The allocation information can indicate the correspondence relationship among vehicle IDs, battery pack IDs, and delivery route IDs. In the example in FIG. 5, package IDs of packages to be delivered are associated for each delivery route ID. It is noted that the correspondence relationship between the delivery route ID and the package IDs may be collected as another information separately from the allocation information shown in FIG. 5.

With the above configuration, the battery pack detached from the electric vehicle once can be allocated to another electric vehicle, and thus the remaining capacity of the battery pack can be effectively used (i.e., used for the next delivery without being charged).

The delivery plan generation unit 54 can generate the delivery plan in which the delivery order of delivery destinations is specified.

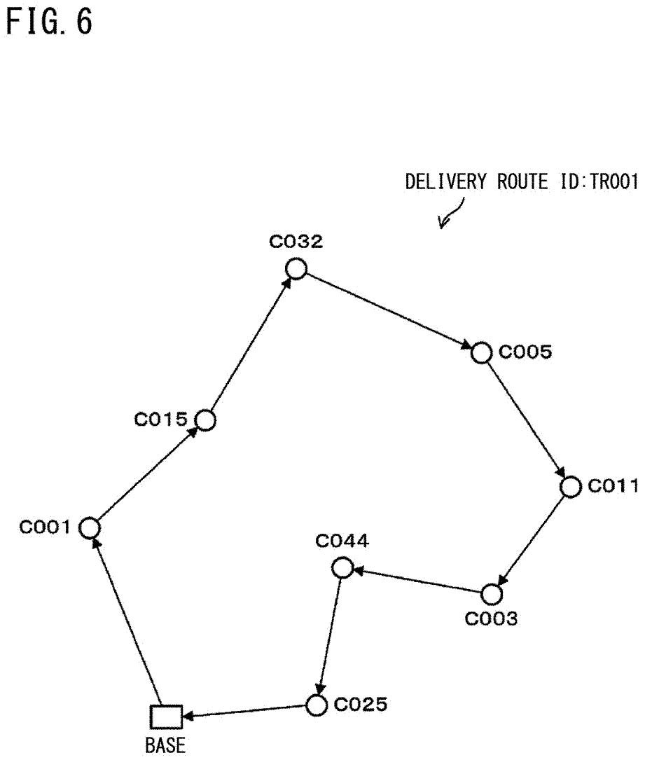

FIG. 6 is a schematic diagram showing an example of the delivery plan. The delivery plan in FIG. 6 corresponds to a delivery plan for one electric vehicle and the delivery route ID thereof is TR001. That is, a different electric vehicle is used for each delivery route ID, and a delivery plan similar to FIG. 6 is generated. The delivery plan shown in FIG. 6 can be displayed on the display device 10.

As shown in FIG. 6, in the delivery plan corresponding to the delivery route ID of TR001, there are delivery destinations specified as C001, C015, C032, C005, C011, C003, C044, C025, and the delivery order is specified by the above order of the delivery destinations. In addition, the delivery order can be specified so that the traveling distance from departure from the delivery base to return thereto is minimized.

Thus, it becomes possible to include many delivery destinations within a range of the remaining capacity of the battery pack mounted to the electric vehicle, or it is possible to generate the delivery plan effectively using the electric vehicle having a less remaining capacity.

In a case where the SOC of the battery pack is equal to or greater than a first threshold, the delivery plan generation unit 54 can generate the delivery plan using the traveling possible distance calculated by the traveling distance calculation unit 53 on the basis of the SOC. The first threshold can be set as appropriate, and for example, can be set to 20%, 30%, or the like. In a case where the distance of the delivery route at the delivery base is long, the first threshold may be increased, and in a case where the distance of the delivery route at the delivery base is comparatively short, the first threshold may be reduced. Thus, repetition of charging in a state close to a full charge state is inhibited, whereby deterioration of the battery pack can be inhibited.

In a case where the SOC of the battery pack is smaller than the first threshold, the charging plan generation unit 57 can generate a charging plan for the battery pack. Performing charging in a case where the SOC is smaller than the first threshold does not lead to promotion of deterioration of the battery pack. Therefore, by charging the battery pack, it is possible to increase the traveling possible distance of the electric vehicle to which the battery pack is mounted, thus enabling delivery of packages to many destinations.

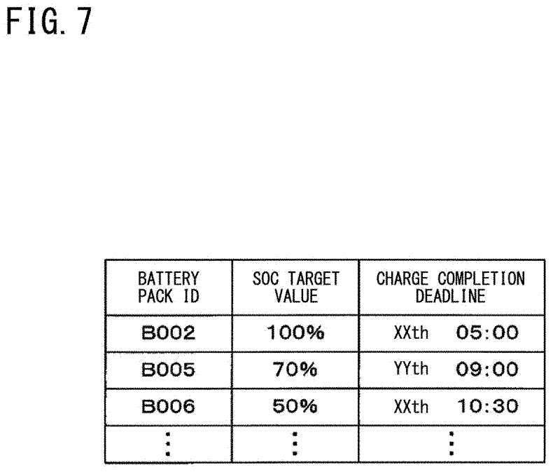

FIG. 7 is a schematic diagram showing an example of a charging plan for each battery pack. As shown in FIG. 7, the charging plan includes a target value for the SOC and a charge completion deadline, for each battery pack.

That is, the charging plan generation unit 57 includes, in the charging plan, a target value for the SOC of the battery pack. The target value may be set to, for example, the upper limit value of the SOC (e.g., 100% or 95%), or depending on the delivery route or the departure time in the next delivery plan, or the like, if it is not necessary to fully charge the battery pack, the target value may be set to 70%, 50%, or the like. Thus, it is possible to charge the battery pack in accordance with the delivery plan.

In addition, the charging plan generation unit 57 includes, in the charging plan, the charge completion deadline based on the delivery plan of the electric vehicle to which the battery pack is mounted. Thus, it is possible to charge the battery pack so as to be ready for the delivery plan.

In a case where a voltage difference between a plurality of battery packs mounted to the electric vehicle is greater than a predetermined threshold, the charging plan generation unit 57 can generate the charging plan so as to charge at least one of the plurality of battery packs.

For example, in a case where battery packs different in the capacities, battery characteristics, and the like of the battery packs are mounted together in one electric vehicle, a voltage difference between the plurality of battery packs may become greater than the predetermined threshold. In such a state, if the battery packs are mounted together (e.g., connected in parallel), an excessive current flows between the plurality of battery packs, thus deteriorating the battery packs. For example, the voltage of a battery pack B1 is defined as V1, and the internal resistance thereof is defined as R1. The voltage of the battery pack B2 is defined as V2, and the internal resistance thereof is defined as R2. When the battery packs B1, B2 are connected in parallel, a current flowing between the battery packs is defined as I, and is represented as I=|V1−V2|/(R1+R2). The voltages V1 and V2 are equalized so that I becomes smaller than Ith. Here, Ith is a threshold. The equalization of the voltages may be performed by charging the battery pack having a lower voltage so as to increase the voltage.

As described above, for example, the battery pack having a low voltage is charged so that the voltage difference between the plurality of battery packs becomes equal to or smaller than the predetermined threshold. Thus, different battery packs can be mounted together in the electric vehicle, whereby the battery packs can be effectively used.

The correction unit 56 can correct the traveling possible distance calculated by the traveling distance calculation unit 53, on the basis of at least one of the SOH or the number of times of charging of the battery pack. For example, in a case where the SOH is reduced, the traveling possible distance can be shortened. In addition, in a case where the number of times of charging is large, the traveling possible distance can be shortened. Thus, it is possible to obtain an appropriate traveling possible distance in accordance with the state of the battery pack.

In addition, the correction unit 56 can correct the traveling possible distance in consideration of gradient information of a road and an average congestion condition (e.g., average trip time) on the delivery route by referring to the map information DB 21 or the like.

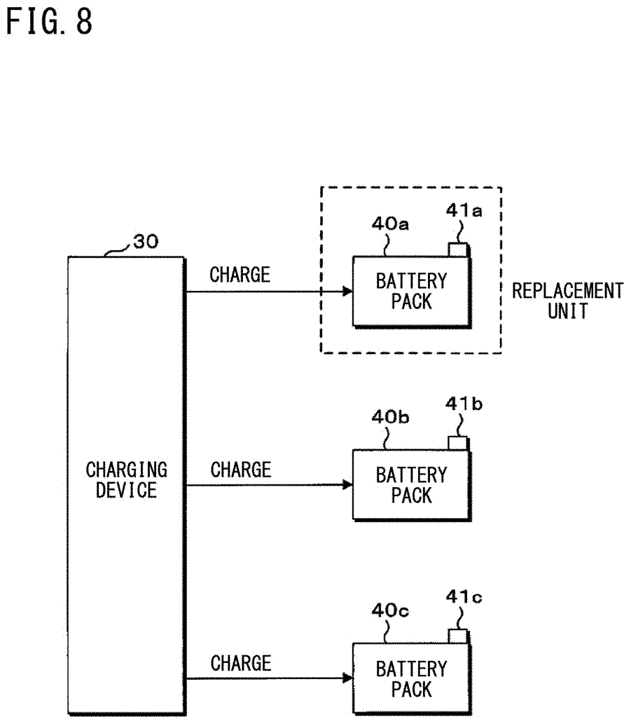

FIG. 8 is a schematic diagram showing a first example of charging of the battery pack by the charging device 30. The charging device 30 can be installed at the delivery base. However, without limitation thereto, the charging device 30 may be installed near the delivery base. In the first example shown in FIG. 8, replacement can be performed in a unit of the battery pack. That is, in a case of replacing the battery pack mounted to the electric vehicle, the battery pack is a replacement unit. A tag 41a on which, for example, a serial number of the battery pack is written, is attached to the battery pack 40a. The same applies to other battery packs 40b, 40c. The charging device 30 can acquire the state of the battery pack (such as SOC and SOH) in advance, for example, via the BMS in the electric vehicle, when the battery pack is mounted in the electric vehicle.

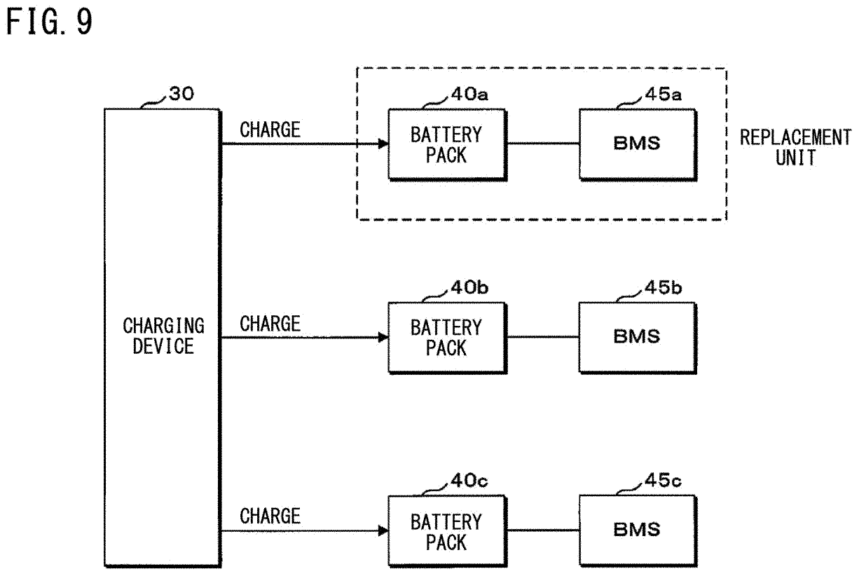

FIG. 9 is a schematic diagram showing a second example of charging of the battery pack by the charging device 30. In the second example shown in FIG. 9, replacement can be performed in a unit of the battery pack and the BMS. That is, in a case of replacing the battery pack mounted to the electric vehicle, the battery pack and the BMS are collectively a replacement unit. For example, the battery pack 40a and a BMS 45a can be collectively attached/detached to/from the electric vehicle. The same applies to other battery packs 40b, 40c. The charging device 30 can acquire the state of the battery pack (such as SOC and SOH) from the BMS, or provide an output to the BMS.

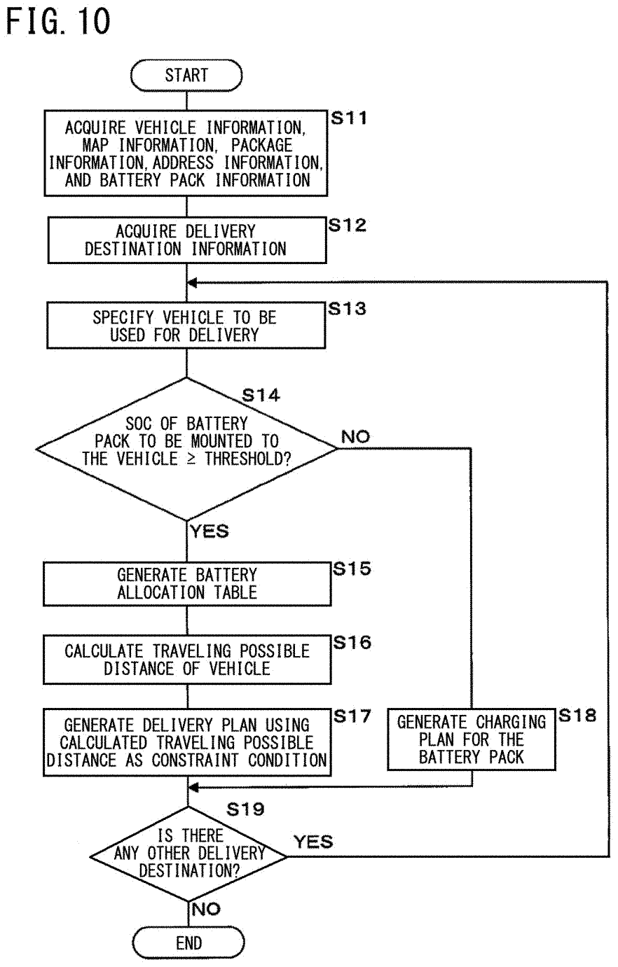

FIG. 10 is a flowchart showing an example of a processing procedure in the delivery plan generation device 50 of the present embodiment. Hereinafter, for convenience sake, description will be given using the control unit 51 as a main unit for the processing. The control unit 51 acquires the vehicle information, the map information, the package information, the address information, and the battery pack information (S11), and acquires the delivery destination information (S12). The control unit 51 specifies a vehicle (electric vehicle) to be used for delivery (S13), and determines whether or not the SOC of the battery pack to be mounted to the vehicle is equal to or greater than the threshold (S14). Here, the battery pack to be mounted to the vehicle is the battery pack mounted to the vehicle that has already returned to the delivery base or that is scheduled to return thereto, but the battery pack stored in the delivery base and scheduled to be mounted to the vehicle may be included.

If the SOC is equal to or greater than the threshold (YES in S14), the control unit 51 generates a battery allocation table (the correspondence relationship between the vehicle ID and the battery pack ID, of the allocation information exemplified in FIG. 5) (S15), and calculates a traveling possible distance for the vehicle on the basis of the SOC of the battery pack allocated to the vehicle in accordance with the battery allocation table, and the like (S16). The control unit 51 generates a delivery plan using the calculated traveling possible distance as a constraint condition (S17), and performs processing in step S19 described later.

If the SOC is not equal to or greater than the threshold (NO in S14), the control unit 51 generates a charging plan for the battery pack (S18), and determines whether or not there is another delivery destination (S19). If there is another delivery destination (YES in S19), that is, if delivery plans for all the delivery destinations have not been completed, the control unit 51 continues the process from step S13. If there is no other delivery destination (NO in S19), the control unit 51 ends the process.

The delivery plan generation device 50 of the present embodiment can be implemented using a general-purpose computer having a CPU (processor), a RAM (memory), and the like. That is, the delivery plan generation device 50 can be implemented on the computer by loading a computer program defining each processing procedure as shown in FIG. 10 into the RAM (memory) provided to the computer, and then executing the computer program by the CPU (processor).

As described above, according to the present embodiment, repetition of charging in a state close to a full charge state can be decreased, whereby deterioration of the battery pack can be inhibited and the life of the battery pack can be prolonged.

The present embodiment is applicable to not only an electric vehicle for which a battery pack can be replaced, but also to an electric vehicle for which replacement of a battery pack is not easy (replacement of a battery pack is not assumed in operation).

In the present embodiment, as means for calculating a delivery route on the basis of delivery destination information, for example, a known service or application may be used.

It should be noted that the embodiments disclosed herein are merely illustrative and not restrictive in all aspects. The scope of the present disclosure is defined by the scope of the claims rather than the above description, and is intended to include meaning equivalent to the scope of the claims and all modifications within the scope.

### REFERENCE SIGNS LIST

10 display device

21 map information DB

22 address information DB

23 package information DB

24 vehicle information DB

25 battery pack information DB

30 charging device

40a, 40b, 40c battery pack

41a, 41b, 41c tag

45a, 45b, 45c BMS

50 delivery plan generation device

51 control unit

52 communication unit

53 traveling distance calculation unit

54 delivery plan generation unit

55 storage unit

56 correction unit

57 charging plan generation unit

58 output unit

59 interface unit

1. A delivery plan generation device configured to generate a delivery plan for a package by an electric vehicle to which a secondary battery is mounted, the delivery plan generation device comprising
a processor configured to:
acquire vehicle information of the electric vehicle;
acquire an SOC of the secondary battery mounted to the electric vehicle;
acquire delivery destination information of the package;
calculate a traveling possible distance of the electric vehicle on the basis of the vehicle information and the SOC of the secondary battery; and
generate the delivery plan, using the delivery destination information and the calculated traveling possible distance.

2. The delivery plan generation device according to claim 1, wherein
the processor configures to generate the delivery plan in which a delivery order of a plurality of delivery destinations is specified.

3. The delivery plan generation device according to claim 1, wherein
the processor generates the delivery plan including allocation information of the secondary battery to be mounted to the electric vehicle for each delivery route from departure from a base to return to the base.

4. The delivery plan generation device according to claim 1, wherein
the processor generates the delivery plan on the basis of the SOC of the secondary battery and a first threshold.

5. The delivery plan generation device according to claim 4, wherein the processor further configures to generate a charging plan for the secondary battery on the basis of the SOC of the secondary battery and the first threshold.

6. The delivery plan generation device according to claim 5, wherein
the charging plan includes, a target value for the SOC of the secondary battery.

7. The delivery plan generation device according to claim 5, wherein
the charging plan generation unit includes, in the charging plan, a charge completion deadline based on the delivery plan of the electric vehicle to which the secondary battery is mounted.

8. The delivery plan generation device according to claim 5, wherein
in response to a voltage difference between a plurality of secondary batteries to be mounted to the electric vehicle being greater than a predetermined threshold, the processor generates the charging plan so as to charge at least one of the plurality of secondary batteries.

9. The delivery plan generation device according to claim 8, wherein
the processor generates the charging plan so as to charge the secondary battery having a low voltage, of the plurality of secondary batteries.

10. The delivery plan generation device according to claim 1, wherein the processor further configures to correct the calculated traveling possible distance, on the basis of at least one of the SOH of the secondary battery or a number of times of charging thereof.

11. A non-transitory computer readable storage medium storing a computer program for causing a computer to generate a delivery plan for a package by an electric vehicle to which a secondary battery is mounted, the computer program causing the computer to execute:
processing of acquiring vehicle information of the electric vehicle;
processing of acquiring an SOC of the secondary battery mounted to the electric vehicle;
processing of acquiring delivery destination information of the package;
processing of calculating a traveling possible distance of the electric vehicle on the basis of the vehicle information and the SOC of the secondary battery; and
processing of generating the delivery plan, using the delivery destination information and the calculated traveling possible distance.

12. A delivery plan generation method for generating a delivery plan for a package by an electric vehicle to which a secondary battery is mounted, the delivery plan generation method comprising:
acquiring vehicle information of the electric vehicle;
acquiring an SOC of the secondary battery mounted to the electric vehicle;
acquiring delivery destination information of the package;
calculating a traveling possible distance of the electric vehicle on the basis of the vehicle information and the SOC of the secondary battery; and
generating the delivery plan, using the delivery destination information and the calculated traveling possible distance.
